(19) United States
(12) Patent Application Publication
(10) Pub. No.: US 2010/0283445 A1
(43) Pub. Date: Nov. 11, 2010

(54) INTEGRATED CIRCUIT HAVING LOW POWER MODE VOLTAGE REGULATOR

(75) Inventors: RAVINDRARAJ RAMARAJU, ROUND ROCK, TX (US); ANDREW C. RUSSELL, AUSTIN, TX (US)

Correspondence Address: FREESCALE SEMICONDUCTOR, INC.;LAW DEPARTMENT, 7700 WEST PARMER LANE MD:TX32/PL02, AUSTIN, TX, 78729, US

(73) Assignee: FREESCALE SEMICONDUCTOR, INC., AUSTIN, TX (US)

(21) Appl. No.: 12/843,547

(22) Filed: Jul. 26, 2010

Related U.S. Application Data
(63) Continuation-in-part of application No. 12/622,277, filed on Nov. 19, 2009.
Application No. 12/622,277 is a continuation-in-part of application No. 12/372,997, filed on Feb. 18, 2009.

(51) Int. Cl. G05F 5/00

(52) U.S. Cl. 323/299

(57) ABSTRACT

A voltage regulator includes a node, circuitry, a regulating transistor, a disabling transistor, and a voltage follower stage. The circuitry is coupled to the node for providing a current to the node. The regulating transistor is coupled between the node and a first power supply voltage terminal. The disabling transistor is coupled in parallel with the regulating transistor for selectively disabling the regulating transistor by directly connecting the first power supply voltage terminal to the node. The voltage follower stage is coupled between the first power supply voltage terminal and a second power supply voltage terminal. The voltage follower stage has an output connected to a control electrode of the regulating transistor, and an input connected to the node.

### CROSS-REFERENCE TO RELATED APPLICATION

This application is a continuation-in-part of U.S. patent application Ser. No. 12/622,277 by Ramaraju et al., filed Nov. 19, 2009, and entitled “Integrated Circuit Having Low Power Mode Voltage Regulator”.

### BACKGROUND

1. Field

This disclosure relates generally to integrated circuits, and more specifically, to an integrated circuit having a low power mode voltage regulator.

2. Related Art

Lower power consumption has been gaining importance in integrated circuits due to, for example, wide spread use of portable and handheld applications. Most circuits in handheld devices are typically off, for example, in an idle or deep sleep mode, for a significant portion of time, consuming only leakage power. As transistor leakage currents increase with finer geometry manufacturing processes, it becomes more difficult to meet chip leakage targets using traditional power reduction techniques. Therefore, reducing leakage current is becoming an increasingly important factor in extending battery life.

There are several methods for reducing leakage currents of integrated circuits during a low power mode. One method involves providing a “virtual” ground terminal that can be at ground potential during a normal operating mode and then increased above ground during a low power operating mode to reduce the leakage current. However, as power supply voltages decrease, it becomes more important to maintain the increased voltage on the virtual ground terminal during the low power operating mode very accurately.

### BRIEF DESCRIPTION OF THE DRAWINGS

The various embodiments are illustrated by way of example and are not limited by the accompanying figures, in which like references indicate similar elements. Elements in the figures are illustrated for simplicity and clarity and have not necessarily been drawn to scale.

FIG. 1 illustrates in schematic form a circuit for voltage control in a semiconductor having a low power mode in accordance with an embodiment.

FIG. 2 illustrates in schematic form a circuit for voltage control in a semiconductor having a low power mode in accordance with another embodiment.

FIG. 3 illustrates in schematic form a circuit for voltage control in a semiconductor having a low power mode in accordance with another embodiment.

FIG. 4 illustrates in schematic diagram form a circuit for voltage control in accordance with another embodiment.

FIG. 5 illustrates in schematic diagram form a circuit for voltage control in accordance with another embodiment.

FIG. 6 illustrates in schematic diagram form a circuit for voltage control in accordance with another embodiment.

FIG. 7 illustrates in schematic diagram form a circuit for voltage control in accordance with another embodiment.

FIG. 8 illustrates in schematic diagram form a circuit for voltage control in accordance with another embodiment.

FIG. 9 illustrates in schematic diagram form a circuit for voltage control in accordance with another embodiment.

### DETAILED DESCRIPTION

In one aspect, there is provided, a voltage regulator, comprising: a node; circuitry coupled to the node for providing a current to the node; a regulating transistor coupled between the node and a first power supply voltage terminal; a disabling transistor coupled in parallel with the regulating transistor for selectively disabling the regulating transistor by directly connecting the first power supply voltage terminal to the node; and a voltage follower stage coupled between the first power supply voltage terminal and a second power supply voltage terminal, the voltage follower stage having an output connected to a control electrode of the regulating transistor, and an input connected to the node. The voltage follower stage may further comprise: an N-channel transistor having a first current electrode coupled to the second power voltage terminal, a control electrode connected to the node, and a second current electrode connected to the control terminal of the regulating transistor; and a P-channel transistor having a first current electrode connected to the second current electrode of the N-channel transistor, a control electrode connected to both the control electrode of the N-channel transistor and the node, and a second current electrode coupled to the first power supply voltage terminal. The first power supply voltage terminal may be coupled to ground and the second power supply voltage terminal may be coupled to a positive power supply voltage terminal. The N-channel transistor may further comprise a body terminal coupled to the first power supply terminal and the P-channel transistor may further comprise a body terminal coupled to the second power supply voltage terminal. The voltage follower stage may further comprise: a load element having a first terminal coupled to the second power supply voltage terminal, and a second terminal connected to the control electrode of the regulating transistor; and a P-channel transistor having a first current electrode connected to both the second terminal of the load element and the control electrode of the regulating transistor, a control electrode connected to the node, and a second current electrode coupled to the first power supply voltage terminal. The voltage follower stage may further comprise: an N-channel transistor having a first current electrode coupled to the second power supply voltage terminal, a control electrode connected to the node, and a second current electrode connected to the control electrode of the regulating transistor; and a load element having a first terminal connected to both the control electrode of the regulating transistor and the second current electrode of the N-channel transistor, and a second terminal connected to the first power supply voltage terminal. The current provided by the circuitry may be a leakage current which occurs during a low power operating mode of the circuitry. The regulating transistor and the disabling transistor may both be characterized as being N-channel transistors. The regulating transistor and disabling transistor may be silicon-on-insulator (SOI) transistors and the voltage follower stage may be implemented with SOI transistors.

In another aspect, there is provided, a voltage regulator comprising: a node; circuitry coupled to the node for providing a current to the node; a regulating transistor coupled between the node and a first power supply voltage terminal; a disabling transistor coupled in parallel with the regulating transistor for selectively disabling the regulating transistor by directly connecting the first power supply voltage terminal to the node; and a voltage follower stage comprising: an N-channel transistor having a first current electrode connected to the second power supply voltage terminal, a control electrode connected to the node, and a second current electrode connected to a control electrode of the regulating transistor; and a P-channel transistor having a first current electrode connected to both a control electrode of the regulating transistor and to the second current electrode of the N-channel transistor, a control electrode connected to the node, and a second current electrode connected to the first power supply voltage terminal. The first power supply voltage terminal may be connected to ground, and the second power supply voltage terminal may be connected to a positive power supply voltage. The N-channel transistor may further comprise a body terminal for being connected to ground, and the P-channel transistor may further comprise a body terminal for being connected to the positive power supply voltage. The current provided by the circuitry may be a leakage current which occurs during a low power operating mode of the circuitry. The regulating transistor and the disabling transistor may both be characterized as being N-channel transistors. The regulating transistor and disabling transistor may be silicon-on-insulator (SOI) transistors and the voltage follower stage may be implemented with SOI transistors.

In yet another aspect, there is provided, a voltage regulator comprising: a node; circuitry coupled to the node for providing a current to the node; a regulating transistor coupled between the node and a first power supply voltage terminal; a disabling transistor coupled in parallel with the regulating transistor for selectively disabling the regulating transistor by directly connecting the first power supply voltage terminal to the node; and a voltage follower stage comprising a load element and a voltage follower transistor connected together in series between the first power supply voltage terminal and the second power supply voltage terminal, wherein a control electrode of the voltage follower transistor is connected to the node, and a current electrode of the voltage follower transistor is connected to a control electrode of the regulating transistor. The load element may have a first terminal connected to the second power supply voltage terminal, and a second terminal connected to the control electrode of the regulating transistor, and wherein the voltage follower transistor may be a P-channel transistor having a first current electrode connected to a second terminal of the load element and to the control electrode of the regulating transistor, and a second current electrode connected to the first power supply voltage terminal. The voltage follower transistor may be an N-channel transistor having a first current electrode connected to the second power supply voltage terminal, a control electrode connected to the node, and a second current electrode connected to a control electrode of the regulating transistor, and wherein the load element may have a first terminal connected to both the control electrode of the regulating transistor and to the second current electrode of the N-channel transistor, and a second terminal connected to the first power supply voltage terminal. The regulating transistor and disabling transistor may be silicon-on-insulator (SOI) transistors and the voltage follower stage may be implemented with SOI transistors. The first power supply voltage terminal may be for being connected to ground, and the second power supply voltage terminal may be for being connected to a positive power supply voltage.

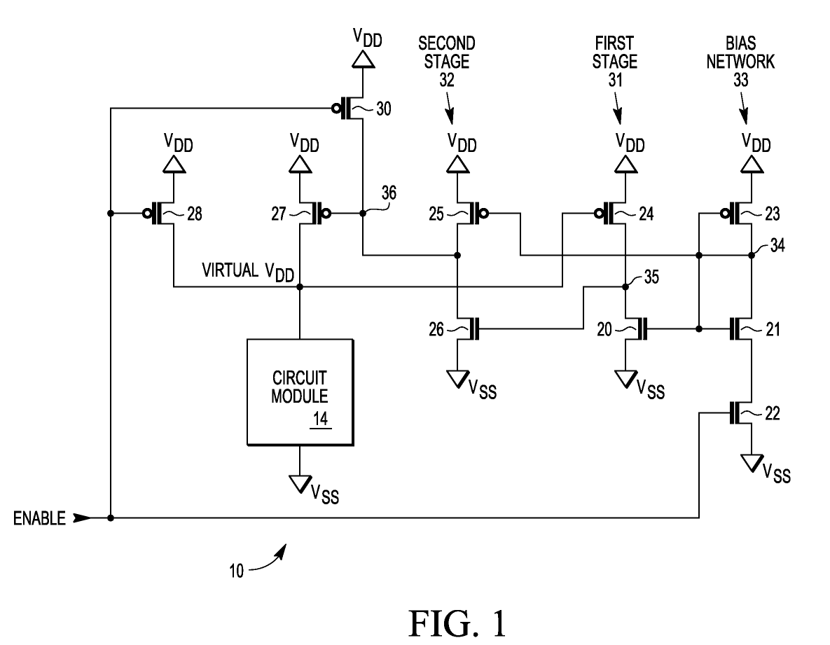

Illustrated in FIG. 1 is circuitry for providing an operating voltage when having a low power or idle mode of operation. Circuit 10 implements a voltage regulating function to accurately maintain a reduced operating voltage without requiring circuitry that itself uses a significant amount of power or requires a significant amount of area. In the illustrated form the circuit 10 has a first stage 31 and a second stage 32 that are biased by a bias network 33. Bias network 33 has a P-channel transistor 23 having a first current electrode or source connected to a voltage terminal for receiving a V_{DD} power supply voltage. A control electrode or gate and a second current electrode or drain of transistor 23 are connected together at a node 34 to form a diode-connected transistor 23. The drain of transistor 23 is connected to a drain of an N-channel transistor 21. A gate of transistor 21 is connected to the gate of transistor 23 at node 34. A source of transistor 21 is connected to a drain of an N-channel transistor 22. A source of transistor 22 is connected to a power supply terminal for receiving a voltage V_{SS}. In one form the V_{SS} is an earth ground potential, but in other forms the V_{SS} voltage may be other voltage values including negative voltages. Regardless of the value of V_{SS}, the power supply voltage V_{DD} is a more positive voltage than V_{SS}. The first stage 31 has a P-channel transistor 24 having a source connected to a power supply voltage terminal for receiving the V_{DD} supply voltage. A gate of transistor 24 is connected to a Virtual V_{DD} node, and a drain of transistor 24 is connected to a drain of an N-channel transistor 20 at a node 35. A gate of transistor 20 is connected to the gates of transistors 21 and 23 at node 34. A source of transistor 20 is connected to a voltage terminal for receiving the V_{SS} voltage. The second stage 32 has a P-channel transistor 25 having a source connected to a terminal for receiving the V_{DD} supply voltage. A gate of transistor 25 is connected to the gates of transistors 21 and 23 and the drain of transistor 23 at the node 34. A drain of transistor 25 is connected to a drain of an N-channel transistor 26 at a node 36. A gate of transistor 26 is connected to the drain of transistor 20 at a node 35, and a source of transistor 26 is connected to a voltage terminal for receiving the V_{SS} voltage. A P-channel transistor 27 has a source connected to a terminal for receiving the V_{DD} supply voltage, a gate connected to the node 36 and a drain connected to the virtual V_{DD} node. A circuit module 14 has a first power supply terminal connected to the virtual V_{DD} node. A second power supply terminal of the circuit module 14 is connected to a voltage terminal for receiving the V_{SS} voltage. The circuit module 14 may be any of a wide variety of types of electronic circuits. For example, circuit module 14 may be digital logic circuitry, a state element such as one or more flip-flops, a memory element such as a cache, a processing unit or a core in a system-on-chip (SOC) or a sea of gates for implementing a logic function. A P-channel transistor 28 has a source connected to a terminal for receiving the V_{DD} supply voltage. A gate of transistor 28 is connected to the gate of a P-channel transistor 30 for receiving an Enable signal. The gate of transistor 22 also receives the Enable signal. In one form the gate of transistor 22 is connected to the gate of transistor 28 and the gate of transistor 30. A drain of transistor 28 is connected to the Virtual ground node. A source of transistor 30 is connected to a terminal for receiving the V_{DD} supply voltage.

In operation, circuit 10 functions to provide either a full supply voltage V_{DD} or a reduced supply voltage to power the circuit module 14. The Enable signal directly determines which voltage, V_{DD} or reduced V_{DD} is coupled to the circuit module 14. When the enable signal is a high logic value to place circuit module 14 of circuit 10 in an idle state of operation, transistors 28 and 30 are nonconductive and transistor 22 is conductive. The idle state of operation is a “drowsy” mode or an “Idle” mode of operation in which circuit module 14 is sufficiently powered to maintain state information at a reduced V_{DD} supply voltage. In this mode of operation, there is typically no normal circuit activity within circuit module 14. Thus the term “Idle mode” is herein used. Any functional activity which might occur during the Idle mode occurs at a reduced frequency. The bias network 33 is enabled and node 34 is set at a bias voltage. Transistors 21, 23 and 25 form a current mirror circuit. The current that is flowing through transistors 21 and 23 is mirrored into transistors 20 and 25. The bias voltage of bias network 33 may assume various values and is determined by the physical and electrical characteristics of transistors 21 and 23. The first stage 31 has a gain element established by transistor 24. A gate-to-source voltage, V_{GS}, is established across transistor 24 on the Virtual V_{DD} node. Transistor 20 functions as a load (i.e. also a current source) for transistor 24. The second stage 32 has a gain element that is established by transistor 26. Transistor 25 functions as a load for transistor 26. Transistor 27 provides a control gate for the first stage 31 and second stage 32 for providing a reduced V_{DD} to the Virtual V_{DD} node. In this way, transistor 27 may be considered a third stage to the first stage 31 and second stage 32 with the circuit module 14 functioning as a load.

The voltage at the virtual V_{DD} node is determined by the V_{GS} of transistor 24. The desired voltage at the virtual V_{DD} node is accomplished by the design of the physical and electrical characteristics of transistors 24 and 20. These characteristics primarily include the transistor channel dimensions and the transistor threshold voltage characteristic. During operation, if the Virtual V_{DD} node drifts downward from the design's operating value, transistor 24 becomes biased stronger and the voltage at node 35 increases. This increase of voltage at node 35 biases transistor 26 stronger which in turn reduces the voltage bias applied to the gate of transistor 27 at node 36. Transistor 27 therefore is biased stronger which has the effect of increasing the voltage at the Virtual V_{DD} node to counter the downward drift of voltage. If the Virtual V_{DD} node drifts upward from the design's operating value, transistor 24 becomes biased weaker and the voltage at node 35 decreases. This decrease of voltage at node 35 biases transistor 26 weaker which in turn increases the voltage bias applied to the gate of transistor 27 at node 36. Transistor 27 therefore is biased less which has the effect of decreasing the voltage at the Virtual V_{DD} node to counter the upward drift of voltage. These voltage relationships function as negative feedback to counter voltage changes (either up or down) at the Virtual V_{DD} node. The negative feedback results from an odd number of stages wherein each stage implements a signal inversion between its input and output. The negative feedback response is determined by the loop gain of the product of the gains of the first stage 31, the second stage 32, and the transistor 27.

When the Enable signal has a low logic value, transistors 28 and 30 are conductive and transistor 22 is nonconductive. The Enable signal places the circuit module 14 in a normal mode of operation. In the normal mode of operation the full supply voltage value, V_{DD}, is connected to the Virtual V_{DD} node by transistor 28. In this mode, the conduction of transistor 30 places the gate of transistor 27 at V_{DD} to make transistor 27 nonconductive. Therefore, transistor 28 is the only transistor device connecting a voltage to the virtual V_{DD} node. When transistor 22 is nonconductive, the bias voltage at node 34 is established at V_{DD}. The transistors 24 and 25 are nonconductive. Transistor 20 is made conductive under these operating conditions. As a result, node 35 is placed at the V_{SS} potential and transistor 26 is therefore nonconductive. Since transistor 30 is conductive, the node 36 is placed at V_{DD} which makes transistor 27 nonconductive. A portion of the circuit 10 remains inoperative until the Enable control signal transitions back to a logic high which indicates entrance into the Idle mode.

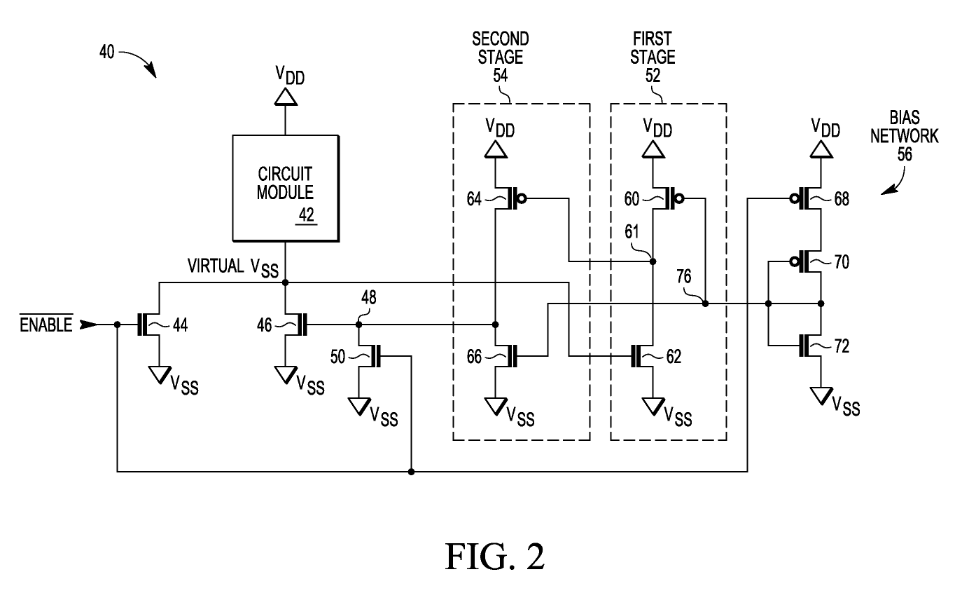

Illustrated in FIG. 2 is a circuit 40 for use in circuitry having a low power or idle mode of operation. Circuit 40 efficiently increases the voltage at a Virtual V_{SS} terminal in response to entering an idle mode of operation wherein a positive power supply voltage V_{DD} does not change in value. A circuit module 42 has a first voltage terminal connected to a terminal for receiving the V_{DD} supply voltage and a second voltage terminal connected to a Virtual V_{SS} terminal. A first stage 52 has a P-channel transistor 60 having a source connected to a terminal for receiving the V_{DD} power supply, a gate connected to a node 76 and a drain connected to a node 61. An N-channel transistor 62 has a drain connected to the drain of transistor 60 at node 61, a gate connected to the Virtual V_{SS} terminal, and a source connected to a terminal for receiving the V_{SS} voltage. A second stage 54 has a P-channel transistor 64 having a source connected to a terminal for receiving the V_{DD} power supply, a gate connected to node 61, and a drain connected to a drain of an N-channel transistor 66 at a node 48. A gate of transistor 66 is connected to a node 76 for receiving a bias voltage. A bias network 56 has a P-channel transistor 68 having a source connected to a terminal for receiving the V_{DD} power supply, a gate for receiving an Enable signal in complementary form, and a drain. An N-channel transistor 70 has a source connected to the drain of transistor 68. A gate of transistor 70 is connected to a drain thereof at node 76 and to a drain of an N-channel transistor 72. A gate of transistor 72 is connected to the drain of transistor 72 at node 76. A source of transistor 72 is connected to a terminal for receiving the V_{SS} power supply. An N-channel transistor 44 has a source connected to a terminal for receiving the V_{SS} power supply, a gate for receiving the Enable signal in complementary form, and a drain connected to the Virtual V_{SS} terminal. An N-channel transistor 46 has a drain connected to the Virtual V_{SS} terminal, a gate connected to node 48, and a source connected to a terminal for receiving the V_{SS} power supply. An N-channel transistor 50 has a drain connected to node 48, a gate for receiving the Enable signal in complementary form, and a source connected to the V_{SS} terminal.

In operation, circuit 40 functions to provide either an original valued voltage V_{SS} or an increased V_{SS} supply voltage to power the circuit module 42. The complement form of the Enable signal (i.e. active low) directly determines which voltage, V_{SS} or increased V_{SS} is coupled to the circuit module 42. When the enable bar signal (i.e. the inverse of the enable signal) is a low logic value to place circuit module 42 of circuit 40 in an idle state of operation, transistors 44 and 50 are nonconductive and transistor 68 is conductive. The idle state of operation is a “drowsy” mode or an idle mode of operation in which circuit module 42 is sufficiently powered to maintain state information using an increased V_{SS} voltage with a V_{DD} supply voltage that is the same as in an active mode of operation. In the idle mode of operation, there is no normal circuit activity within the circuit module 42. Thus the term “idle” mode is herein used. The bias network 56 is enabled and node 76 is set at a bias voltage. Transistors 72, 70 and 66 form a current mirror circuit. The current that is flowing through transistors 70 and 72 is mirrored into transistors 60 and 66. The bias voltage of bias network 56 may assume various values and is determined by the physical and electrical characteristics of transistors 70 and 72. The first stage 52 has a gain element established by transistor 62. A gate-to-source voltage, V_{GS}, is established across transistor 62 on the Virtual V_{SS} node. Transistor 60 functions as a load (i.e. also a current source) for transistor 62. The second stage 54 has a gain element that is established by transistor 64. Transistor 66 functions as a load for transistor 64. Transistor 46 provides a control gate for the first stage 52 and second stage 54 for providing an increased V_{SS} to the Virtual V_{SS} node. In this way, transistor 46 may be considered a third stage to the first stage 52 and second stage 54 with the circuit module 42 functioning as a load.

The voltage at the virtual V_{SS} node is determined by the V_{GS} of transistor 62. The desired voltage at the virtual V_{SS} node is accomplished by the design of the physical and electrical characteristics of transistors 62 and 60. These characteristics primarily include the transistor channel dimensions and the transistor threshold voltage characteristic. During operation, if the Virtual V_{SS} node drifts downward from the design's operating value, transistor 62 becomes biased weaker and the voltage at node 61 increases. This increase of voltage at node 61 biases transistor 64 weaker which in turn reduces the voltage bias applied to the gate of transistor 46 at node 48. Transistor 46 therefore is biased weaker which has the effect of increasing the voltage at the Virtual V_{SS} node to counter the downward drift of voltage. If the Virtual V_{SS} node drifts upward from the design's operating value, transistor 62 becomes biased stronger and the voltage at node 61 decreases. This decrease of voltage at node 61 biases transistor 64 stronger which in turn increases the voltage bias applied to the gate of transistor 46 at node 48. Transistor 46 therefore is biased stronger which has the effect of decreasing the voltage at the Virtual V_{SS} node to counter the upward drift of voltage. These voltage relationships function as negative feedback to counter voltage changes (either up or down) at the Virtual V_{SS} node. The negative feedback results from an odd number of stages wherein each stage implements a signal inversion between its input and output. The negative feedback response is determined by the loop gain of the product of the gains of the first stage 52, the second stage 54 and the transistor 46.

When the Enable BAR signal has a high logic value and circuit 40 is not in the Idle mode of operation, transistors 44 and 50 are conductive and transistor 68 is nonconductive. The high logic value of Enable BAR signal places the circuit module 42 in a normal mode of operation. In the normal mode of operation the normal or predetermined voltage value for V_{SS} is connected to the Virtual V_{SS} node by transistor 44. In this mode, the conduction of transistor 50 places the gate of transistor 46 at V_{SS} to make transistor 46 nonconductive. Therefore, transistor 44 is the only transistor device connecting a voltage to the virtual V_{SS} node. When transistor 68 is nonconductive, the bias voltage at node 76 is established at V_{SS}. The transistors 62 and 66 are nonconductive. Transistor 60 is made conductive under these operating conditions. As a result, node 61 is placed at the V_{DD} potential and transistor 64 is therefore nonconductive. Since transistor 50 is conductive, the node 48 is placed at V_{SS} which makes transistor 46 nonconductive. The circuit 40 remains operative until the Enable BAR control signal transitions back to a logic low value which indicates entrance into the Idle mode of operation.

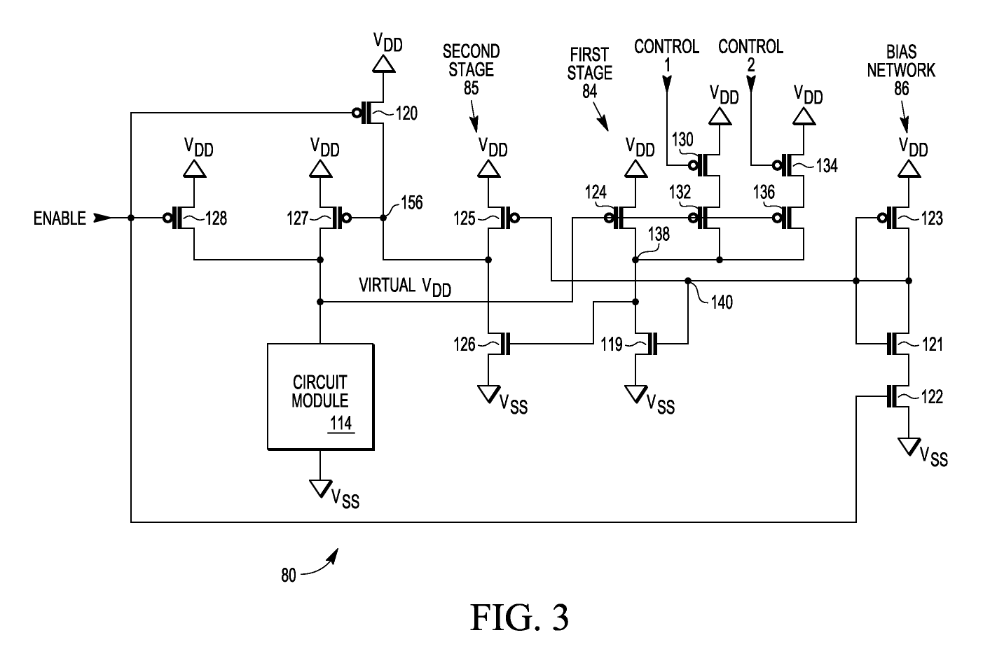

Illustrated in FIG. 3 is a circuit 80 for providing an operating voltage in accordance with yet another form of the present invention. Circuit 80 is programmable, such as by a user of a system incorporating circuit 80, for determining a value of operating voltage that is used during an idle mode of operation of a circuit module 114. The circuit module 114 has a first voltage terminal connected to a terminal for receiving a V_{SS} voltage which, in one form, is an earth ground. A second voltage terminal of circuit module 114 is connected to a Virtual V_{DD} node. A P-channel transistor 128 has a source connected to a terminal for receiving a supply voltage terminal for receiving supply voltage V_{DD}. The supply voltage V_{DD} is more positive than the V_{SS} supply voltage. A gate of transistor 128 is coupled to an Enable signal, and a drain of transistor is connected to the Virtual V_{DD} node. A P-channel transistor 127 has a source connected to a supply voltage terminal for receiving supply voltage V_{DD}. A gate of transistor 127 is connected to a node 156 and a drain of transistor 127 is connected to the Virtual V_{DD} node. A P-channel transistor 120 has a source connected to a terminal for receiving a supply voltage terminal for receiving supply voltage V_{DD}. A gate of transistor 120 is coupled to the Enable signal, and a drain of transistor 120 is connected to the gate of transistor 127 at node 156. An amplifier has a first stage 84 and a second stage 85 that are biased by a bias network 86. The bias network 86 has a P-channel transistor 123 having a source connected to a terminal for receiving the supply voltage V_{DD}. A gate of transistor 123 is connected to a drain thereof and to a node 140 for providing an output of the bias network 86. The drain of transistor 123 is connected to both a gate and a drain of an N-channel transistor 121. Both transistor 123 and 121 are therefore connected to form a diode. A source of transistor 121 is connected to a drain of an N-channel transistor 122. Transistor 122 has a gate for receiving the Enable signal and has a source connected to a terminal for receiving the supply voltage V_{SS}. Within the first stage 84, a P-channel transistor 124 has a source connected to a terminal for receiving the supply voltage V_{DD}. A gate of transistor 124 is connected to the Virtual V_{DD} node. A drain of transistor 124 is connected to a drain of an N-channel transistor 119 at a node 138. A gate of transistor 119 is connected to node 140, and a source of transistor 119 is connected to a terminal for receiving the supply voltage V_{SS}. A P-channel transistor 130 has a source connected to a terminal for receiving the supply voltage V_{DD}. A gate of transistor 130 is coupled to a first control signal labeled ‘Control 1’. A drain of transistor 130 is connected to a source of a P-channel transistor 132. A gate of transistor 132 is connected to the Virtual V_{DD} node. A drain of transistor 132 is connected to node 138. A P-channel transistor 134 has a source connected to a terminal for receiving the supply voltage V_{DD}. A gate of transistor 134 is coupled to a second control signal labeled ‘Control 2’. A drain of transistor 134 is connected to a source of a P-channel transistor 136. A gate of transistor 136 is connected to the Virtual V_{DD} node. A drain of transistor 136 is connected to node 138. A second stage 85 has a P-channel transistor 125 having a source connected to a terminal for receiving the supply voltage V_{DD}. A gate of transistor 125 is coupled to the output of the bias network 86 at the node 140. A drain of transistor 125 is connected to the gate of transistor 127 at node 156 and to a drain of an N-channel transistor 126. A gate of transistor 126 is connected to an output of the first stage 84 by being connected to the drain of transistor 124 at node 138. A source of transistor 126 is connected to a terminal for receiving the supply voltage V_{SS}.

In operation, circuit 80 functions to provide either a full supply voltage V_{DD} or a reduced supply voltage to power the circuit module 114. The Enable signal directly determines which voltage, V_{DD} or reduced V_{DD} is coupled to the circuit module 114. When the Enable signal is a high logic value circuit module 114 is placed in an idle state of operation. Transistors 128 and 120 are nonconductive and transistor 122 is conductive. The idle state of operation is a “drowsy” mode or an idle mode of operation in which circuit module 114 is sufficiently powered to maintain state information at a reduced V_{DD} supply voltage. In this mode of operation, there is no normal circuit activity within circuit module 114. The bias network 86 is enabled and node 140 is set at a bias voltage. Transistors 121, 123 and 125 form a current mirror circuit. The current that is flowing through transistors 121 and 123 is mirrored into transistors 119 and 125. The bias voltage of bias network 86 may assume various values and is determined by the physical and electrical characteristics of transistors 121 and 123. Unlike the implementation of FIG. 1, the first stage 84 has a programmable gain element established by transistor 124 and the selection via a plurality of control signals. Series-connected transistors 130 and 132 and series-connected transistors 134 and 136 form a programming circuit for setting the gate-to-source voltage of transistor 124. Series-connected transistors 130 and 132 and series-connected transistors 134 and 136 each form a transistor pair of P-channel devices. The transistor pairs are selectively enabled to conduct current by the user programmable control signals. It should be understood that any number of pairs of series-connected transistors may be connected to node 138 to provide current to node 138. When one or both of the illustrated pairs of series-connected transistors are enabled to conduct current in response to the control signals, the conducting transistors change the gate-to-source voltage, V_{GS}, of transistor 124. The additional coupling of transistors between the V_{DD} power supply terminal and node 138 has the affect of changing the physical characteristics of transistor 124 by adding more effective channel width to the transistor 124. This additional channel width changes the V_{GS}. A change in the gate-to-source voltage of transistor 124 changes the voltage at the virtual V_{DD} node because the V_{GS} is related to the voltage at the virtual V_{DD} node.

A gate-to-source voltage, V_{GS}, established across transistor 124 and any enabled pair of transistors coupled in parallel between V_{DD} and node 138 is on the Virtual V_{DD} node. Transistor 119 functions as a load (i.e. also a current source) for transistor 124 and any enabled pair of transistor connected to node 138. The second stage 85 has a gain element that is established by transistor 126. Transistor 125 functions as a load for transistor 126. Transistor 127 provides a control gate for the first stage 84 and second stage 85 for providing a reduced V_{DD} to the Virtual V_{DD} node. In this way, transistor 127 may be considered a third stage to the first stage 84 and second stage 85 with the circuit module 114 functioning as a load.

The voltage at the virtual V_{DD} node is determined by the V_{GS} of transistor 124 and any enabled pair of transistors coupled in parallel between V_{DD} and node 138. The desired voltage at the virtual V_{DD} node is accomplished by the design of the physical and electrical characteristics of transistors 124 and 119 and any enabled pair of transistors. These characteristics primarily include the transistor channel dimensions and the transistor threshold voltage characteristic. During operation, if the Virtual V_{DD} node drifts downward from the design's operating value, transistor 124 and any enabled pair of transistors become biased stronger and the voltage at node 138 increases. This increase of voltage at node 138 biases transistor 126 stronger which in turn reduces the voltage bias applied to the gate of transistor 127 at node 156. Transistor 127 therefore is biased stronger which has the effect of increasing the voltage at the Virtual V_{DD} node to counter the downward drift of voltage. If the Virtual V_{DD} node drifts upward from the design's operating value, transistor 124 and any enabled pair of transistors becomes biased weaker and the voltage at node 138 decreases. This decrease of voltage at node 138 biases transistor 126 weaker which in turn increases the voltage bias applied to the gate of transistor 127 at node 156. Transistor 127 therefore is biased less which has the effect of decreasing the voltage at the Virtual V_{DD} node to counter the upward drift of voltage. These voltage relationships function as negative feedback to counter voltage changes (either up or down) at the Virtual V_{DD} node. The negative feedback results from an odd number of stages wherein each stage implements a signal inversion between its input and output. The negative feedback response is determined by the loop gain of the product of the gains of the first stage 84, the second stage 85 and the transistor 127.

When the enable signal has a low logic value, transistors 128 and 120 are conductive and transistor 122 is nonconductive. The enable signal places the circuit module 114 in a normal mode of operation. In the normal mode of operation the full supply voltage value, V_{DD}, is connected to the Virtual V_{DD} node by transistor 128. In this mode, the conduction of transistor 120 places the gate of transistor 127 at V_{DD} to make transistor 127 nonconductive. Therefore, transistor 128 is the only transistor device connecting a voltage to the virtual V_{DD} node. When transistor 122 is nonconductive, the bias voltage at node 140 is established at V_{DD}. The transistors 124 and 125 are nonconductive. Transistor 119 is made conductive under these operating conditions. As a result, node 138 is placed at the V_{SS} potential and transistor 126 is therefore nonconductive. Since transistor 120 is conductive, the node 156 is placed at V_{DD} which makes transistor 127 nonconductive. A portion of the circuit 80 remains inoperative until the enable control signal transitions back to a logic high which indicates entrance into the Idle mode.

In another form of circuit 80, instead of using transistors 130, 132, 134, 136 to program variation of the Virtual V_{DD} node voltage, the current through transistor 119 can be varied to program the virtual V_{DD} node voltage. In other words, transistor 119 may be implemented as a variable current source which also functions as a load. An advantage of either form of FIG. 3 is that circuit 80 may be utilized as a standard cell element in a standard cell library whenever a drowsy voltage controller is desired.

In another form of circuit 80, instead of using transistors 130, 132, 134 and 136 to program variation of the Virtual V_{DD} node voltage, the bulk terminal of a MOSFET implementing transistor 124 could be varied to produce the desired change in the Virtual V_{DD} voltage.

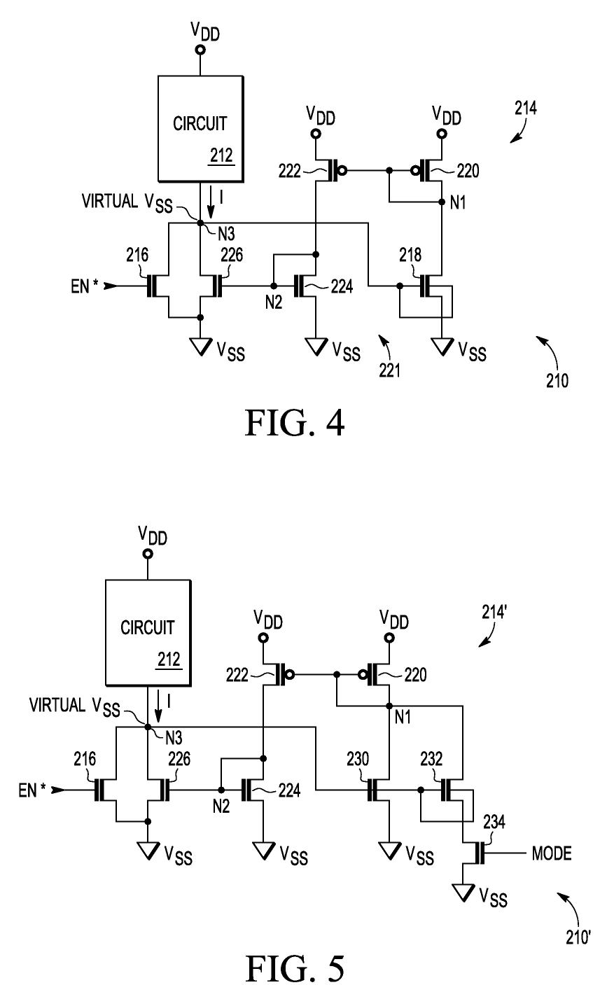

FIG. 4 illustrates in schematic diagram form a circuit 210 for voltage control in accordance with another embodiment. Circuit 210 includes circuit 212 and voltage regulator 214. Voltage regulator 214 includes disable transistor 216, sensing transistor 218, load transistor 220, transistors 222 and 224, and regulating transistor 226. Transistors 222 and 224 are coupled together to form an inverting stage 221. Transistors 216, 218, 224, and 226 are N-type MOS (metal oxide semiconductor) transistors and transistors 220 and 222 are P-type MOS transistors implemented on an integrated circuit. In one embodiment, circuit 210 is implemented using CMOS (complementary metal-oxide semiconductor) transistors on a silicon-on-insulator (SOI) substrate. In other embodiments, integrated circuit 210 can be implemented on another type of substrate using a different transistor type.

Circuit 212 can be any type of circuit that would benefit from leakage reduction during low power mode. For example, circuit 212 can be one or more logic circuits or a plurality of memory cells, or a combination of logic and memory. In one embodiment, circuit 212 is an array of static random access memory (SRAM) cells. Circuit 212 has a first power supply voltage terminal connected to V_{DD} and a second power supply terminal connected to node N3. A leakage current labeled “I” will be present when circuit 212 is in a low power mode. In one embodiment, V_{DD} is a positive power supply voltage equal to about 0.9 volts and V_{SS} is generally ground. In another embodiment, V_{DD} may be ground while V_{SS} is negative. Also, in other embodiments, the power supply voltage may be any voltage. During low power mode the voltage at the V_{SS} terminal is increased above ground to reduce the leakage current from circuit 212.

Disable transistor 216 has a first current electrode connected to a node N3 labeled “VIRTUAL V_{SS}”, a control electrode connected to receive an enable signal labeled “EN*”, and a second current electrode connected to a power supply voltage terminal labeled “Vss”. Sensing transistor 218 has a first current electrode connected to a node N1, a control electrode and a body terminal both connected to node N3, and a second current electrode connected to V_{SS}. In other embodiments, the body terminal of transistor 218 may be connected to another node, such as for example, V_{SS}. Load transistor 220 has a first current electrode connected to a power supply voltage terminal labeled “V_{DD}”, a control electrode and a second current electrode both connected to the first current electrode of transistor 218 at node N1. P-channel transistor 222 has a first current electrode connected to V_{DD}, a control electrode connected to the control electrode of transistor 220, and a second current electrode. Transistor 224 has a first current electrode connected to the second current electrode of transistor 222, a control electrode connected to the second current electrode of transistor 222, and a second current electrode connected to V_{SS}. Regulating transistor 226 has a first current electrode connected to the first current electrode of transistor 216, a control electrode connected to the control electrode of transistor 224 at node N2, and a second current electrode connected to V_{SS}. The body terminals (not shown) of N-channel transistors 216, 224, and 226 are connected to ground and the body terminals (not shown) of P-channel transistors 220 and 222 are connected to V_{DD}.

During a normal mode of operation, circuit 212 is active and receives a normal operating power supply voltage at V_{DD}. The enable signal EN* is negated as a logic high to make transistor 216 conductive, thus connecting node N3 to V_{SS} so that node N3 is at substantially V_{SS}. Transistor 218 is substantially non-conductive as node N3 is at substantially VSS potential. Node N1 is substantially V_{DD} potential so that transistors 220 and 222 are substantially non-conductive. Node N2 is at VSS potential so transistors 224 and 226 are substantially non-conductive. Because transistors 218, 220, 222, and 224 are non-conductive, the leakage current or standby current is reduced. Note that the asterisk (*) after the signal name indicates that the signal is a logical complement of a signal having the same name but lacking the asterisk (*).

During a low power mode, enable signal EN* is asserted as a logic low voltage causing transistor 216 to be substantially non-conductive. Leakage current labeled “I” in FIG. 4 will cause the voltage at node N3 to increase. Transistors 220, 222, and 224 provide a feedback path from node N1 to node N2. Generally, the gate of sensing transistor 218 is coupled to sense the voltage at node N3. When transistor 218 responds to the increasing voltage, the feedback path controls the voltage at the control electrode of regulating transistor 226 to maintain the voltage at node N3 at a predetermined voltage level. The body terminal of transistor 218 is connected to node N3 so that an increasing voltage at node N3 lowered the threshold voltage (VT) of transistor 218. Lowering the VT is this manner improves the conductivity of the transistor 218 without increasing the size of transistor 218. In one embodiment with a power supply voltage of 0.9 volts, the predetermined voltage level is about 300 millivolts (mV) above V_{SS}, where V_{SS} is at ground potential in the illustrated embodiment. In another embodiment, the predetermined voltage level is different. More specifically, during low power mode, the increasing voltage at node N3 will cause transistor 218 to start to become conductive, decreasing the voltage at node N1. The decreasing voltage at node N1 will bias transistors 220 and 222 to start to become conductive. When transistor 222 becomes conductive, the voltage at node N2 will increase. The increasing voltage at node N2 will cause transistor 226 to be conductive and reduce the voltage at node N3. Thus, regulating transistor 226 will maintain the voltage at node N3 the predetermined voltage level above V_{SS}.

Because the power supply voltage is already very low (e.g. 0.9 volts), and due to variations in the process and the electrical characteristics of the transistors and the power supply voltage, the data state of circuit 212 may become easily corruptible, or unstable, when transitioning from a normal mode to a low power mode. In the case where circuit 212 is an SRAM array, increasing the voltage at node N3 too much can reduce margins to the point where memory cells inadvertently change logic states. Therefore, it is important that the voltage at node N3 transition smoothly and without any overshoot of the predetermined voltage above ground. In voltage regulator 214, transistors 222 and 224 form a very low gain inverting stage so that the voltage transitions at node N3 are over-dampened. This functions to maintain adequate margins in the memory cells that would otherwise be compromised if the voltage at node N3 had any overshoot. Adding margin to accommodate any overshoot at node N3 would reduce the predetermined voltage above ground that the virtual VSS could rise. This would increase the amount of leakage current. Therefore, it is desirable to have a circuit that consumes a small current to regulate the voltage at N3 while having an over-dampened response (no overshoot), while also having adequate gain to maintain the voltage at node N3 at the predetermined voltage level above VSS.

FIG. 5 illustrates in schematic diagram form a circuit 210′ for voltage control in accordance with another embodiment. Circuit 210′ includes circuit 212 and voltage regulator 214′. Voltage regulator 214′ differs from voltage regulator 214 in that voltage regulator 214′ includes a pair of parallel connected transistors 230 and 232 in place of the single transistor 218 in voltage regulator 214. Also, transistor 232 can be enabled or disabled by asserting a mode signal MODE at a control electrode of transistor 234. Transistor 230 has a first current electrode connected to node N1, a second current electrode connected to V_{SS}, and a control electrode connected to node N3. Transistor 232 has a first current electrode connected to node N1, a second current electrode, a control electrode connected to the control electrode of transistor 230, and a body terminal connected to node N3. Transistor 234 has a first current electrode connected to the second current electrode of transistor 232, a second current electrode connected to V_{SS}, and a control electrode for receiving mode signal MODE. The body terminal of transistor 230 is connected to V_{SS}. Note that in FIG. 5, the body terminal of transistor 232 is connected to node N3. However, the body terminal of transistor 230 can be connected to node N3 instead of V_{SS}. Also, in other embodiments the body terminals of both of transistors 230 and 232 can be connected to node N3. In addition, in other embodiments, the body terminals of neither of transistors 230 and 232 are connected to node N3.

In operation, voltage regulator 214′ functions similarly to voltage regulator 214 except that voltage regulator 214′ can maintain node N3 (VIRTUAL VSS) at one of two different predetermined voltage levels. When operating in a low power mode and mode signal MODE is not asserted, transistor 234 is substantially non-conductive and only transistor 230 controls the voltage at node N1 in response to the voltage level at node N3 (VIRTUAL VSS) as described above in the discussion of FIG. 4. However, when operating in low power mode and mode signal MODE is asserted, transistor 234 is conductive and both transistors 230 and 232 work together to lower the voltage at node N1. This causes regulating transistor 226 to become more conductive than the embodiment describe above with respect to FIG. 4, so that the voltage at node N3 is pulled lower than if transistor 230 was working alone. In one embodiment, the voltage at node N3 is maintained at about 200 mV when mode signal MODE is asserted, and the voltage at node N3 is maintained at about 300 mV when mode signal MODE is negated.

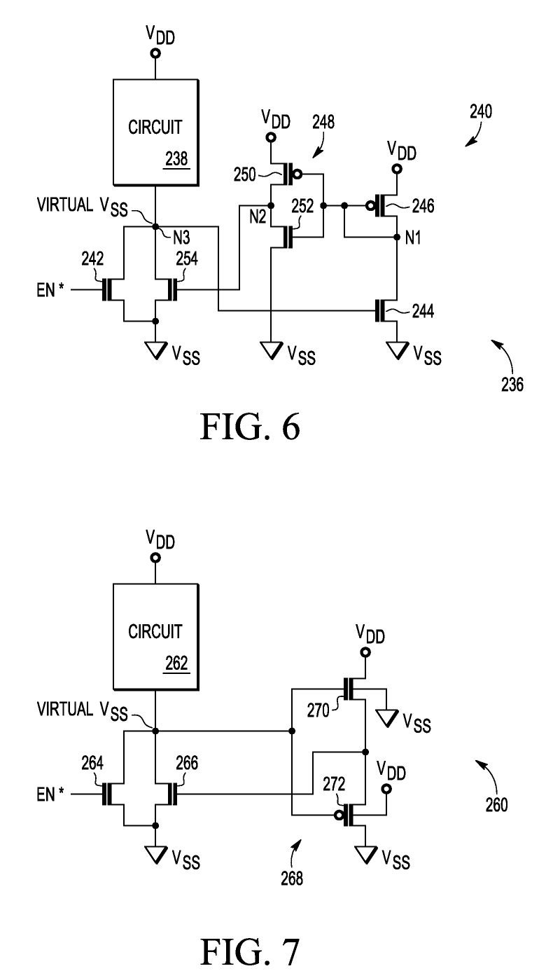

FIG. 6 illustrates, in schematic diagram form, a circuit 236 for voltage control in accordance with another embodiment. Circuit 236 includes circuit 238 and voltage regulator 240. Voltage regulator 240 includes N-channel transistors 242, 244, 252, and 254 and P-channel transistors 246 and 250. Generally, integrated circuit 236 differs from integrated circuit 210 in FIG. 4 in that the inverting stage 221 of FIG. 4 is replaced with a CMOS inverter 248. Inverter 248 includes P-channel transistor 250 and N-channel transistor 252.

During a normal mode of operation, circuit 238 is active with switching transistors and receives a normal operating power supply voltage at V_{DD}. The enable signal EN* is negated as a logic high to make transistor 242 conductive, thus connecting node N3 to V_{SS} so that node N3 is at substantially V_{SS}.

During a low power mode, enable signal EN* is asserted as a logic low voltage causing transistor 242 to be substantially non-conductive. The leakage current, labeled “I” will cause the voltage at node N3 to increase above ground. Transistor 246 and inverter 248 provide a feedback path from node N1 to node N2. Generally, the gate of sensing transistor 244 is coupled to sense the voltage at node N3. When transistor 244 responds to the increasing voltage at node N3, the feedback path controls the voltage at the control electrode of regulating transistor 254 to maintain the voltage at node N3 at a predetermined voltage level. In one embodiment with a power supply voltage of 0.9 volts, the predetermined voltage level is about 300 millivolts (mV) above ground. In another embodiment, the predetermined voltage level is different. More specifically, during low power mode, the increasing voltage at node N3 will cause transistor 244 to start to become conductive, decreasing the voltage at node N1. The decreasing voltage at node N1 will bias an input terminal of inverter 248 so that the output voltage of inverter 248 at node N2 will increase. The increasing voltage at node N2 will cause transistor 254 to be conductive and reduce the voltage at node N3. Thus, regulating transistor 254 will maintain the voltage at node N3 the predetermined voltage level above V_{SS}. Note that in another embodiment, a body terminal (not shown) of sensing transistor 244 may be connected to node N3 in a similar manner as transistor 218 in FIG. 4 and transistor 234 as illustrated in FIG. 5.

Because the power supply voltage is already very low (e.g. 0.9 volts), and because of variations in the process and electrical characteristics of the transistors and the power supply voltage, transitioning from a normal mode to a low power mode may cause the data state of circuit 238 to become easily corruptible. In the case where circuit 238 is an SRAM array, increasing the voltage at node N3 too much can reduce bit cell margins to the point where the bit cells inadvertently change logic states. Therefore, it is important that the voltage at node N3 transition smoothly to the predetermined voltage without overshooting the predetermined voltage. In voltage regulator 240, transistors 250 and 252 form a relatively low gain inverting stage so that the voltage transitions at node N3 are dampened less than the inverting stage 221 of FIG. 4. By using a relatively low gain inverting stage, overshoot of the predetermined voltage at node N3 can be avoided, and adequate margins in the memory cells can be maintained.

FIG. 7 illustrates, in schematic diagram form, a voltage regulating circuit 260 in accordance with another embodiment. Circuit 260 implements a voltage regulating function to accurately maintain a reduced operating voltage to circuit 262. Circuit 260 performs this function without using a significant amount of power or surface area on an semiconductor device. Voltage regulator 260 includes regulating N-channel transistor 266, disabling transistor 264, and voltage follower stage 268. Voltage follower stage 268 includes N-channel transistor 270 and P-channel transistor 272 connected in series between power supply voltage terminal V_{DD} and power supply voltage terminal V_{SS}. Voltage follower stage 268 is connected between V_{DD} and V_{SS} and has an output connected to a control electrode of regulating transistor 266, and an input connected to node VIRTUAL V_{SS}. In one embodiment, V_{DD} is a positive power supply voltage of about 0.9 volts and V_{SS} is at ground potential.

N-channel transistor 266 has a first current electrode connected to circuit 262 at a node labeled “VIRTUAL V_{SS}”, a control electrode, and a second current electrode connected to V_{SS}. In one embodiment, voltage regulator 260 is implemented using a conventional complementary metal-oxide semiconductor (CMOS) process where the current electrodes are source or drain terminals depending on the conductivity type of the transistor, and the control electrode is a gate. N-channel transistor 264 is connected in parallel with transistor 266 and has a first current electrode connected to node VIRTUAL V_{SS}, a control electrode for receiving enable signal EN*, and a second control electrode connected to V_{SS}. In voltage follower stage 268, N-channel transistor 270 has a first current electrode connected to power supply voltage terminal V_{DD}, a control electrode connected to node VIRTUAL V_{SS}, and a second current electrode connected to the control electrode of transistor 266. P-channel transistor 272 has a first current electrode connected to both the second current electrode of transistor 270 and to the control electrode of transistor 266, a control electrode connected to both the control electrode of transistor 270 and to the node VIRTUAL V_{SS}, and a second current electrode connected to V_{SS}. Transistor 270 has a body terminal connected to V_{SS} and transistor 272 has a body terminal connected to V_{DD}. In one embodiment, circuit 260 is implemented on a silicon-on-insulator (SOI) integrated circuit.

In operation, circuit 260 functions to provide either a full supply voltage V_{DD} or a reduced supply voltage to circuit 262. During a normal operating mode, the full supply voltage V_{DD} is provided when enable signal EN* is asserted as a logic high voltage so that transistor 264 is on, or conductive, connecting circuit 262 directly to V_{SS}. During a reduced power operating mode, enable signal EN* is asserted as a logic low voltage causing transistor 264 to be substantially non-conductive. During the reduced power operating mode, circuit 262 may be functioning at reduced frequency or may be idle. Even when circuit 262 is idle, a leakage current will flow between V_{DD} and V_{SS}. The term “idle” has been defined above. Voltage regulator 260 raises a voltage at node VIRTUAL V_{SS} above V_{SS} so that circuit 262 receives a lower power supply voltage to reduce the leakage current.

When circuit 262 is operating in the reduced power mode, regulating transistor 266 is biased to maintain node VIRTUAL V_{SS} at a predetermined voltage above V_{SS}, for example, 0.2 volts above V_{SS}. Voltage follower stage 268 provides a feedback path from node VIRTUAL VSS to the control electrode of transistor 266. The predetermined voltage is accomplished by the design of the physical and electrical characteristics of transistors 266, 270, and 272. During operation, if the voltage at node VIRTUAL V_{SS} decreases, transistor 270 becomes less conductive and transistor 272 becomes more conductive. When transistor 272 becomes more conductive, the voltage at the control electrode of transistor 266 is reduced, causing transistor 266 to be less conductive so that the voltage at node VIRTUAL V_{SS} is increased. If the voltage at node VIRTUAL V_{SS} increases, transistor 272 becomes less conductive and transistor 270 becomes more conductive. When transistor 270 becomes more conductive, the voltage at the control electrode of transistor 266 is increased, causing transistor 266 to be more conductive, thus reducing the voltage at node VIRTUAL V_{SS}. These voltage relationships function as feedback to counter voltage changes (either up or down) at node VIRTUAL V_{SS}.

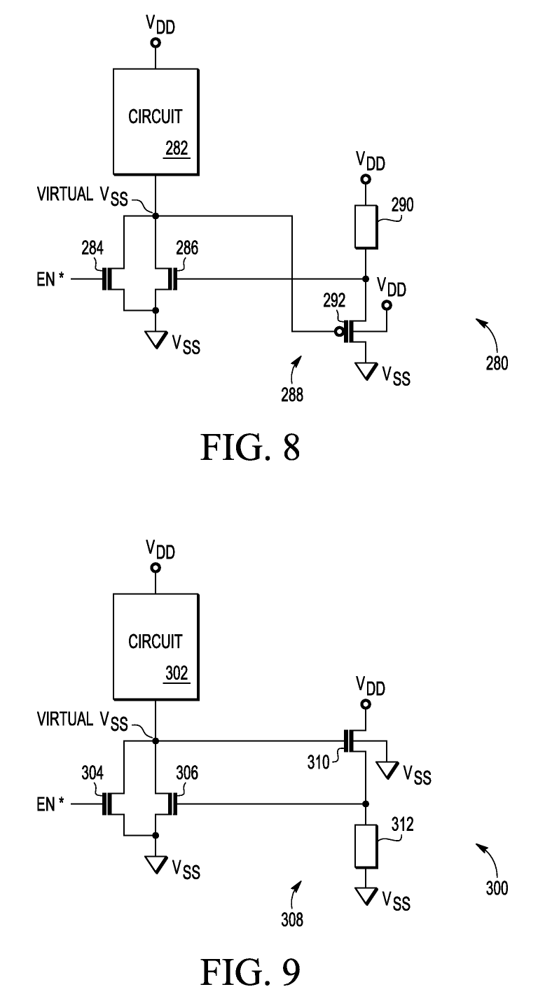

FIG. 8 illustrates, in schematic diagram form, a voltage regulating circuit 280 in accordance with another embodiment. More specifically, circuit 280 is another embodiment of a voltage regulating circuit using a voltage follower in a feedback path. Circuit 280 includes disabling N-channel transistor 284, regulating transistor 286, and voltage follower stage 288. Voltage follower stage 288 includes load element 290 and P-channel transistor 292 connected in series between V_{DD} and V_{SS}. In one embodiment, V_{DD} is a positive power supply voltage and V_{SS} is at ground potential.

N-channel transistor 286 has a first current electrode connected to circuit 282 at a node labeled “VIRTUAL V_{SS}”, a control electrode, and a second current electrode connected to V_{SS}. In one embodiment, voltage regulator 280 is implemented using a conventional complementary metal-oxide semiconductor (CMOS) process where the current electrodes are source or drain terminals depending on the conductivity type of the transistor, and the control electrode is a gate. N-channel transistor 284 is connected in parallel with transistor 286 and has a first current electrode connected to node VIRTUAL V_{SS}, a control electrode for receiving enable signal EN*, and a second current electrode connected to V_{SS}. In voltage follower stage 288, Load element 290 has a first terminal connected to V_{DD}, and a second terminal. Load element 290 may be a passive load element such as a resistor, or an active load element such as a transistor. P-channel transistor 292 has a first current electrode connected to both the second terminal of load element 290 and to the control electrode of transistor 286, a control electrode connected to node VIRTUAL V_{SS}, and a second current electrode connected to V_{SS}. Transistor 292 also has a body terminal connected to V_{DD}. In one embodiment, circuit 280 is implemented on a SOI integrated circuit.

In operation, circuit 280 functions to provide either a full supply voltage V_{DD} or a reduced supply voltage to circuit 282. During a normal operating mode, the full supply voltage V_{DD} is provided when enable signal EN* is asserted as a logic high voltage so that transistor 284 is on, or conductive, connecting circuit 282 directly to V_{SS}. During a reduced power operating mode, enable signal EN* is asserted as a logic low voltage causing transistor 284 to be substantially non-conductive. During the reduced power operating mode, circuit 282 may be functioning at a reduced frequency or may be idle. Even when circuit 282 is idle, a leakage current will flow between V_{DD} and V_{SS}. The term “idle” has been defined above. Voltage regulator 280 raises a voltage at node VIRTUAL V_{SS} above V_{SS} so that circuit 282 receives a reduced power supply voltage to reduce the leakage current.

When circuit 282 is operating in the reduced power mode, regulating transistor 286 is biased to maintain node VIRTUAL V_{SS} at a predetermined voltage above V_{SS}, for example, 0.2 volts above V_{SS}. Voltage follower stage 288 provides a feedback path from node VIRTUAL V_{SS} to the control electrode of transistor 286. The predetermined voltage is accomplished by the design of the physical and electrical characteristics of transistors 286 and 292 and load element 290. During operation, if the voltage at node VIRTUAL V_{SS} decreases, transistor 292 becomes more conductive. When transistor 292 becomes more conductive, the voltage at the control electrode of transistor 286 is reduced, causing transistor 286 to be less conductive so that the voltage at node VIRTUAL V_{SS} is increased. If the voltage at node VIRTUAL V_{SS} increases, transistor 292 becomes less conductive and the voltage at the control electrode of transistor 286 increases, causing transistor 286 to be more conductive, thus reducing the voltage at node VIRTUAL V_{SS}. These voltage relationships function as feedback to counter voltage changes (either up or down) at node VIRTUAL V_{SS}.

FIG. 9 illustrates, in schematic diagram form, a voltage regulating circuit 300 in accordance with another embodiment. Voltage regulating circuit 300 is substantially the same as voltage regulating circuit 280, except that the location of the load element and transistor of the voltage follower are reversed. Voltage regulating circuit 300 includes N-channel transistors 304 and 306 and voltage follower 308. Voltage follower 308 includes N-channel transistor 310 and load element 312, where N-channel transistor 310 has a first current electrode connected to V_{DD}, a control electrode connected to node VIRTUAL V_{SS}, and a second current electrode connected to the control electrode of transistor 306.

In operation, circuit 300 functions to provide either a full supply voltage V_{DD} or a reduced supply voltage to circuit 302. During a normal operating mode, the full supply voltage V_{DD} is provided when enable signal EN* is asserted as a logic high voltage so that transistor 304 is on, or conductive, connecting circuit 302 directly to V_{SS}. During a reduced power operating mode, enable signal EN* is asserted as a logic low voltage causing transistor 304 to be substantially non-conductive. During the reduced power operating mode, circuit 302 may be functioning at reduced frequency or may be idle. Even when circuit 302 is idle, a leakage current will flow between V_{DD} and V_{SS}. The term “idle” has been defined above. Voltage regulator 300 raises a voltage at node VIRTUAL V_{SS} above V_{SS} so that circuit 302 receives a reduced power supply voltage to reduce the leakage current.

When circuit 302 is operating in the reduced power mode, regulating transistor 306 is biased to maintain node VIRTUAL V_{SS} at a predetermined voltage above V_{SS}, for example, 0.2 volts above V_{SS}. Voltage follower stage 308 provides a feedback path from node VIRTUAL V_{SS} to the control electrode of transistor 306. The predetermined voltage is accomplished by the design of the physical and electrical characteristics of transistors 306 and 310 and load element 312. During operation, if the voltage at node VIRTUAL V_{SS} decreases, transistor 310 becomes less conductive. When transistor 310 becomes less conductive, the voltage at the control electrode of transistor 306 is reduced, causing transistor 306 to be less conductive so that the voltage at node VIRTUAL V_{SS} is increased. If the voltage at node VIRTUAL V_{SS} increases, transistor 310 becomes more conductive and the voltage at the control electrode of transistor 306 increases, causing transistor 306 to be more conductive, thus reducing the voltage at node VIRTUAL V_{SS}. These voltage relationships function as feedback to counter voltage changes (either up or down) at node VIRTUAL V_{SS}.

By now it should be appreciated that there has been provided various embodiments of a voltage circuit that accurately provides a reduced voltage and is size and power efficient. The voltage circuit described herein avoids the need of an operational amplifier or a reference voltage generator to establish an accurate voltage for a reduced power mode of operation. The virtual V_{DD} and virtual V_{SS} voltage values of the various circuit embodiments described herein track with variations in the threshold voltage variations of transistors within a same circuit. For example, while the threshold voltages of transistors 27 and 24 of FIG. 1 each vary, they will vary proportionately and the effects are minimized so that the Virtual V_{DD} voltage remains substantially unaffected by transistor threshold voltage variation. The embodiments described herein have circuit component characteristic variations that have been largely compensated for and the reduced voltage value can be accurately established within a very small margin for variation. By using a self-biasing constant current load inverter with signal feedback, the virtual V_{DD} or virtual V_{SS} voltage is accurately regulated. For example, in FIG. 1 the signal feedback path is from the Virtual V_{DD} node to the gate of transistor 24 which affects the voltage of node 35 which affects the bias of transistor 26 which affects the voltage of node 36 which affects the bias of transistor 27 which affects the Virtual V_{DD} node. Since this biasing network tracks with threshold voltage changes, the stability of the value of the voltage of the Virtual V_{DD} node is excellent. In all embodiments, the small amount of required circuitry (as opposed to a voltage regulator having an operational amplifier or voltage reference) is small in terms of circuit area and power consumption.

Although the invention has been described with respect to specific conductivity types or polarity of potentials, skilled artisans appreciate that conductivity types and polarities of potentials may be reversed. In an alternative any of the embodiments described herein may be implemented by reversing the conductivities of each of the transistors from what is shown. In such embodiments it should be understood that functionality of specific transistors also reverses. For example, the gain devices and the load devices will reverse in such alternate embodiments.

In other alternative forms of FIG. 1, additional circuitry (not shown) may be used to make both of transistors 28 and 27 conductive in response to the Enable signal being in an inactive low state. For example an inversion of the enable signal may be connected to the gate of an N-channel transistor that is connected between the gate of transistor 27 and V_{SS}. The additional N-channel transistor would connect V_{SS} to the gate of transistor 27 when the enable signal is in an inactive low state which would bias transistor 27 on. In such an alternative form both transistors 28 and 27 would source current from the V_{DD} supply to the Virtual V_{DD} node and to circuit module 14.

In alternative forms of FIG. 2, additional circuitry (not shown) may be used to make both of transistors 44 and 46 conductive in response to the Enable bar signal being in an inactive high state. For example an inversion of the enable bar signal may be connected to the gate of a P-channel transistor that is connected between the gate of transistor 46 and V_{DD}. The additional P-channel transistor would connect V_{DD} to the gate of transistor 46 when the enable signal is in an inactive high state which would bias transistor 46 on. In such an alternative form both transistors 44 and 46 would sink current to the V_{SS} supply from the Virtual V_{SS} node and from circuit module 14.

In other alternative forms of FIG. 3, additional circuitry (not shown) may be used to make both of transistors 128 and 127 conductive in response to the Enable signal being in an inactive low state. For example an inversion of the enable signal may be connected to the gate of an N-channel transistor that is connected between the gate of transistor 127 and V_{SS}. The additional N-channel transistor would connect V_{SS} to the gate of transistor 127 when the enable signal is in an inactive low state which would bias transistor 127 on. In such an alternative form both transistors 128 and 127 would source current from the V_{DD} supply to the Virtual V_{DD} node and to circuit module 114.

It should further be understood that the loads described in all embodiments may be implemented as either an active load or a passive load. For example, the transistors 20 and 25 of FIG. 1 may be implemented either as active loads (transistors, thyristors, etc.) or as passive loads (resistive devices such as resistors, capacitive devices such as capacitors, etc.).

The term “coupled,” as used herein, is not intended to be limited to a direct coupling or a mechanical coupling. Although the invention is described herein with reference to specific embodiments, various modifications and changes can be made without departing from the scope of the present invention as set forth in the claims below. For example, various types of transistors may be implemented, such as MOS (metal oxide semiconductor), bipolar, GaAs, silicon on insulator (SOI) and others. The amount of power supply voltage reduction can be adjusted according to specific application requirements. Accordingly, the specification and figures are to be regarded in an illustrative rather than a restrictive sense, and all such modifications are intended to be included within the scope of the present invention. Any benefits, advantages, or solutions to problems that are described herein with regard to specific embodiments are not intended to be construed as a critical, required, or essential feature or element of any or all the claims.

The terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles.

Unless stated otherwise, terms such as “first” and “second” are used to arbitrarily distinguish between the elements such terms describe. Thus, these terms are not necessarily intended to indicate temporal or other prioritization of such elements.

What is claimed is:

1. A voltage regulator, comprising:
a node;
circuitry coupled to the node for providing a current to the node;
a regulating transistor coupled between the node and a first power supply voltage terminal;
a disabling transistor coupled in parallel with the regulating transistor for selectively disabling the regulating transistor by directly connecting the first power supply voltage terminal to the node; and
a voltage follower stage coupled between the first power supply voltage terminal and a second power supply voltage terminal, the voltage follower stage having an output connected to a control electrode of the regulating transistor, and an input connected to the node.

2. The voltage regulator of claim 1, wherein the voltage follower stage further comprises:
an N-channel transistor having a first current electrode coupled to the second power voltage terminal, a control electrode connected to the node, and a second current electrode connected to the control terminal of the regulating transistor; and
a P-channel transistor having a first current electrode connected to the second current electrode of the N-channel transistor, a control electrode connected to both the control electrode of the N-channel transistor and the node, and a second current electrode coupled to the first power supply voltage terminal.

3. The voltage regulator of claim 2, wherein the first power supply voltage terminal is for being coupled to ground and the second power supply voltage terminal is for being coupled to a positive power supply voltage terminal.

4. The voltage regulator of claim 2, wherein the N-channel transistor further comprises a body terminal coupled to the first power supply terminal and the P-channel transistor further comprises a body terminal coupled to the second power supply voltage terminal.

5. The voltage regulator of claim 1, wherein the voltage follower stage further comprises:
a load element having a first terminal coupled to the second power supply voltage terminal, and a second terminal connected to the control electrode of the regulating transistor; and
a P-channel transistor having a first current electrode connected to both the second terminal of the load element and the control electrode of the regulating transistor, a control electrode connected to the node, and a second current electrode coupled to the first power supply voltage terminal.

6. The voltage regulator of claim 1, wherein the voltage follower stage further comprises:
an N-channel transistor having a first current electrode coupled to the second power supply voltage terminal, a control electrode connected to the node, and a second current electrode connected to the control electrode of the regulating transistor; and
a load element having a first terminal connected to both the control electrode of the regulating transistor and the second current electrode of the N-channel transistor, and a second terminal connected to the first power supply voltage terminal.

7. The voltage regulator of claim 1, wherein the current provided by the circuitry is a leakage current which occurs during a low power operating mode of the circuitry.

8. The voltage regulator of claim 1, wherein the regulating transistor and the disabling transistor are both characterized as being N-channel transistors.

9. The voltage regulator of claim 1, wherein the regulating transistor and disabling transistor are silicon-on-insulator (SOI) transistors and the voltage follower stage is implemented with SOI transistors.

10. A voltage regulator comprising:
a node;
circuitry coupled to the node for providing a current to the node;
a regulating transistor coupled between the node and a first power supply voltage terminal;
a disabling transistor coupled in parallel with the regulating transistor for selectively disabling the regulating transistor by directly connecting the first power supply voltage terminal to the node; and
a voltage follower stage comprising:
an N-channel transistor having a first current electrode connected to the second power supply voltage terminal, a control electrode connected to the node, and a second current electrode connected to a control electrode of the regulating transistor; and
a P-channel transistor having a first current electrode connected to both a control electrode of the regulating transistor and to the second current electrode of the N-channel transistor, a control electrode connected to the node, and a second current electrode connected to the first power supply voltage terminal.

11. The voltage regulator of claim 10, wherein the first power supply voltage terminal is for being connected to ground, and the second power supply voltage terminal is for being connected to a positive power supply voltage.

12. The voltage regulator of claim 11, wherein the N-channel transistor further comprises a body terminal for being connected to ground, and the P-channel transistor further comprises a body terminal for being connected to the positive power supply voltage.

13. The voltage regulator of claim 10, wherein the current provided by the circuitry is a leakage current which occurs during a low power operating mode of the circuitry.

14. The voltage regulator of claim 10, wherein the regulating transistor and the disabling transistor are both characterized as being N-channel transistors.

15. The voltage regulator of claim 10, wherein the regulating transistor and disabling transistor are silicon-on-insulator (SOI) transistors and the voltage follower stage is implemented with SOI transistors.

16. A voltage regulator comprising:
a node;
circuitry coupled to the node for providing a current to the node;
a regulating transistor coupled between the node and a first power supply voltage terminal;
a disabling transistor coupled in parallel with the regulating transistor for selectively disabling the regulating transistor by directly connecting the first power supply voltage terminal to the node; and
a voltage follower stage comprising a load element and a voltage follower transistor connected together in series between the first power supply voltage terminal and the second power supply voltage terminal, wherein a control electrode of the voltage follower transistor is connected to the node, and a current electrode of the voltage follower transistor is connected to a control electrode of the regulating transistor.

17. The voltage regulator of claim 16, wherein the load element has a first terminal connected to the second power supply voltage terminal, and a second terminal connected to the control electrode of the regulating transistor, and wherein the voltage follower transistor is a P-channel transistor having a first current electrode connected to a second terminal of the load element and to the control electrode of the regulating transistor, and a second current electrode connected to the first power supply voltage terminal.

18. The voltage regulator of claim 16, wherein the voltage follower transistor is an N-channel transistor having a first current electrode connected to the second power supply voltage terminal, a control electrode connected to the node, and a second current electrode connected to a control electrode of the regulating transistor, and wherein the load element has a first terminal connected to both the control electrode of the regulating transistor and to the second current electrode of the N-channel transistor, and a second terminal connected to the first power supply voltage terminal.

19. The voltage regulator of claim 16, wherein the regulating transistor and disabling transistor are silicon-on-insulator (SOI) transistors and the voltage follower stage is implemented with SOI transistors.

20. The voltage regulator of claim 16, wherein the first power supply voltage terminal is for being connected to ground, and the second power supply voltage terminal is for being connected to a positive power supply voltage.
